(19) United States
(12) Patent Application Publication
(10) Pub. No.: US 2002/0046713 A1
(43) Pub. Date: Apr. 25, 2002

(54) Method for remotely controlling movement of an animal

(76) Inventor: James R. Otto, Severna Park, MD (US)

Correspondence Address: LAW OFFICES OF ROYAL W. CRAIG, Suite 1319, 210 N. Charles St., Baltimore, MD, 21201, US

(21) Appl. No.: 09/949,012

(22) Filed: Sep. 7, 2001

Related U.S. Application Data
(60) Provisional application No. 60/231,356, filed on Sep. 8, 2000.

(51) Int. Cl. A01K 15/02; A01K 15/04

(52) U.S. Cl. 119/720

(57) ABSTRACT

A system and method for precise remote guidance of animals such as rats, dogs, horses, birds, etc., inclusive of remote monitoring of the animal's location, orientation and movement, and graduated stimulus or feedback as to whether or not the movement and orientation is correct. The system incorporates a remote monitoring capability for monitoring the animal's location, orientation and movement, plus a remote stimulus mechanism to apply positive and/or negative reinforcement to the animal depending on whether or not the movement direction and/or orientation is correct. The reinforcement is applied in varying degrees pursuant to a gradient scale. This way, the animal learns to associate movement in the correct direction and/or proper orientation as gradually increasing positive reinforcement and/or reducing negative reinforcement.

### CROSS-REFERENCE TO RELATED APPLICATIONS

The present application derives priority from U.S. Provisional patent application Ser. No. 60/231,356 for “METHOD FOR REMOTELY CONTROLLING THE MOVEMENT AND BEHAVIOR OF AN ANIMAL”; Filed: Sep. 8, 2000; Inventor: Otto, James.

### BACKGROUND OF THE INVENTION

1. Field of the invention

The present invention relates to the remote control of animal behavior and, more specifically, to a system and method for remote guidance of animal movement of, for example, rats, dogs, horses, birds, etc., which includes remote monitoring of the animal's location and movement, and stimulus or feedback as to whether or not the movement is correct.

2. Description of the Background

Since the work of Skinner and Pavlov, a large body of research has developed all generally directed to the control of animal behavior through positive and negative reinforcement. However, little of this research has found any commercial application.

For one, a variety of pet training devices evolved from the concept. For example, U.S. Pat. No. 3,874,339 shows an anti-pull animal leash collar for an animal (such as a dog). An electronic device is attached to the collar, and a leash is coupled to the device. When the animal pulls excessively on the leash, the device provides electrical shocks to the animal, thus causing the animal to refrain from excessive pulling.

Another known application is the electric dog fence, a wide variety of which are readily commercially available. For example, U.S. Pat. No. 5,425,330 shows a system for controlling an animal including a radio signal receiver unit which is attached to the animal. The receiver includes a speaker circuit for applying audible stimulation, and a transformer circuit for applying electrical stimulation. The type of stimulation and the duration of stimulation may be selected according to control parameters used in conjunction with the control sequence.

There have been a number of more exotic efforts. For example, U.S. Pat. Nos. 4,304,193 and 4,765,276 show remote control jockey simulators for physically manipulating a horse to control its movement. Motors control the tensioning of reins connected to the head of the horse, and a control signal is transmitted for remote control. In the latter case, video and two-way audio communications are provided with the remote controller.

Notwithstanding the above, relatively little benefit has come from our ability to control animal movement. Their image processing and movement capabilities (even simple animals) have evolved over tens of millions of years. Their image processing, olfactory senses, fine navigation, and movement capabilities far exceed any supercomputer or robot that we currently have or are likely to have in the foreseeable future. This is especially true when considering size and agility. These innate animal capabilities provide a significant resource that is yet to be exploited.

Recent advances in computers, tracking systems, telecommunications, and electronic miniaturization provide the technologies to allow us to remotely monitor and guide animal movement. There are a wide variety of potential areas where animals, under the remote control of a human or computer, could conceivably perform functions that could not otherwise be performed. For instance, it is not currently possible to send a robotic ground vehicle over complex terrain and have it independently navigate a route. This is because the computer processing and algorithms necessary to make fine maneuvering decisions (such as which rocks to climb over and which rocks to go around) are not currently available. This is to say nothing about the mechanical challenges involved in machine movement. On the other hand, given general route guidance, animals can navigate complex terrain and make the fine maneuvering decisions themselves.

In addition, relatively little work has been done in the area of animal cueing, which is different from reinforcement. Cueing with, for example, tonal or visual cues has no inherent meaning. Thus, for any cueing an animal may need preconditioning to ensure that tonal and visual cues are associated with right or wrong. In contrast, reinforcement such as electroshock has inherent meaning. The prior art operates through reinforcement.

Accordingly, it would be greatly advantageous to provide a system for remotely monitoring and guiding animal movement by cueing and/or reinforcement.

### SUMMARY OF THE INVENTION

It is, therefore, an object of the present invention to provide a system for remote guidance of animals such as rats, dogs, horses, birds, etc., which includes remote monitoring of the animal's location and movement, and stimulus or feedback as to whether or not the movement is correct.

It is another object to provide a system as described above which facilitates autonomous decision making and independent navigation or maneuvering over complex terrain (such as wooded or mountainous regions).

It is still another object to provide a graduated system that applies more or less stimulus and reinforcement as needed depending on the degree of deviation from prescribed behaviors.

It is still another object to provide a system that allows remote guidance of animals through environments inaccessible to humans (such as hostile or confined areas) for purposes of reconnaissance, search and rescue.

According to the present invention, the above-described and other objects are accomplished by providing a gradient method for controlling animal movement. The gradient method includes the steps of monitoring the behavior of an animal relative to a behavioral goal, and providing gradient feedback to the animal in a degree proportional to the degree of deviation of actual behavior from the behavioral goal. In a preferred embodiment, both location and orientation of the animal are monitored, and two gradient reinforcement signals are imparted to the animal, including a first gradient cueing and/or reinforcement stimulus proportional to a degree of deviation from a desired location, and a second gradient cueing and/or reinforcement stimulus proportional to a degree of deviation from a desired orientation. The above-described method is implemented by an animal-borne device including an onboard tracking module for monitoring location and orientation and for transmission of data indicative thereof to a remote location, and an onboard stimulus module for providing gradient feedback to the animal in a degree proportional to deviation from desired location and orientation. In addition, a control module is manned by a user for controlling the animal. The control module receives the data from the onboard tracking module, calculates gradient control parameters, and transmits gradient stimulus commands back to the animal-borne onboard stimulus module.

The onboard tracking module preferably includes a differential GPS receiver and a compass connected to a transmitter. The onboard stimulus module preferably comprises a receiver connected to a stimulus-imparting device for applying feedback to the animal. The stimulus-imparting device may impart any of a variety of different stimuli including neural, aural, visual, and/or electric shock.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a block diagram of a preferred embodiment of the present apparatus.

FIG. 2 is a flow chart showing the operation of the embodiment shown in FIG. 1.

FIG. 3 is a graph of the virtual stimulus and reinforcement landscape generated by the controller 10 of the present invention.

FIG. 4 illustrates a gradient stimulus and reinforcement function in the context of audio tone stimulus that varies with orientation.

FIG. 5 illustrates a gradient amplitude stimulus and reinforcement finction that varies with distance from the desired location.

FIG. 6 illustrates a gradient stimulus and reinforcement finction in the context of a tonal cueing mechanism that provides differential tones to each ear that vary with orientation.

FIG. 7 illustrates a stimulus and reinforcement pulse train that varies with distance from the desired location.

### DETAILED DESCRIPTION OF THE PREFERRED EMBODIMENTS

The system of the present invention includes the method and apparatus for remotely guiding the movement of biological entities (such as rats, dogs, horses, birds, etc.) for a variety of reconnaissance purposes. Gross movements of the animal are maintained under remote human and/or computer control, while fine navigation decisions (such as how to go around an obstacle) are left to the animal.

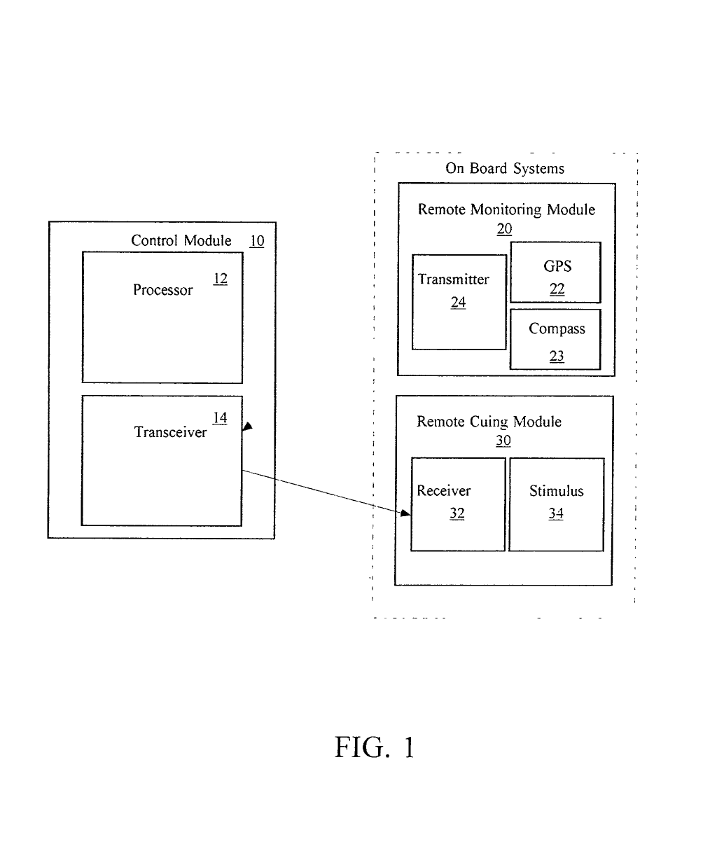

FIG. 1 is a block diagram of a preferred embodiment of the present apparatus. The apparatus generally includes an onboard unit either worn by or implanted in the animal, and a remote control module for manipulating behavior via the onboard unit. The onboard unit further includes a remote monitoring module 20 for monitoring location and movement, and a remote stimulus module 30 for applying feedback to inform the animal about whether or not the movement direction is correct, and to provide positive or negative reinforcement stimulus based on the correctness of the movement. The remote control module 10 receives data from the remote monitoring module 20, and calculates, generates, and transmits stimulus and reinforcement control parameters back to the stimulus module 30 for administration to the animal. In accordance with the method of the present invention, the degree of animal reinforcement is a function of the correctness of its orientation and location. Preferably, the animal is rewarded by positive reinforcement for correct movement (such as onboard delivery of food, water, fast acting narcotics, or direct brain stimulation of the animal's pleasure centers). In addition, the animal is punished for incorrect orientation and/or movement by onboard application of negative reinforcement (such as an aversive cutaneous shock, aversive brain stimulation, or mechanical bridle and spurs). Simultaneous cueing feedback is provided such as acoustical tones varying in frequency, amplitude, and phase, or mechanical bridles and spurs. Through associative learning, the animal learns to associate movement in the correct direction as increasing positive reinforcement and reducing negative reinforcement.

As seen in FIG. 1, the remote control module 10 comprises a transceiver 14, processor 12, and the requisite software to calculate, generate, and transmit stimulus and reinforcement control parameters to the animal based on the distance of the animal's current location and orientation from the desired location. An onboard Remote Monitoring Module 20 preferably includes a differential GPS receiver 22 and electronic compass 23 both connected to a transmitter 24 for transmitting coordinate and orientation data for monitoring the animal's location, orientation and movement. A variety of suitable differential GPS receivers with internal compasses are commercially available, the small size and accuracy being the primary goals. An onboard Remote Cueing Module 30 includes a receiver 32 for receiving control parameters from the remote controller 10, and a stimulus-imparting device 34 for applying feedback to inform the animal about whether or not the movement direction and orientation is correct. The tonal stimulus-imparting device 34 for the illustrated embodiment may be a simple pair of headphones or onboard speakers. However, one skilled in the art should recognize that a variety of existing animal stimuli may be used so long as they can be adapted to be worn by the animal. It is also noteworthy that the stimuli may take the form of cueing or reinforcement (or both), these two types of stimulus being different. The cueing, such as the foregoing tonal cues, may alternately be colored light cues. Cueing has no inherent meaning, and for any cueing the animal may need preconditioning to ensure that tonal and visual cues are associated with right or wrong as desired. In contrast, negative reinforcement such as electroshock has inherent negative meaning and positive reinforcement has inherent positive meaning. For purposes of the present invention, these two types of stimuli (cueing and reinforcement) may be employed either separately or together to supplement each other. It is also well-known that an animal's sensory functions can be directly stimulated by implantation of electrodes in the brain. Thus, the stimulus-imparting device 34 may comprise implanted electrodes for creating pleasurable stimulation as positive reinforcement.

One skilled in the art should also understand that certain physical aspects of the present invention can be consolidated. For instance, the stimulus mechanism 30 and tracking mechanism 20 may be independent components or may be combined and commonly controlled by a single multi-tasked microprocessor. Similarly, the control module 10 may be incorporated directly on the animal (along with the stimulus mechanism 30 and tracking mechanism 20) for autonomous operations. Furthermore, one skilled in the art will understand that the orientation and location tracking accomplished by the differential GPS receiver 22 and electronic compass 23 can be performed manually simply by visual observation either directly or by mounting a video camera on the animal near or with the onboard Remote Cueing Module 30.

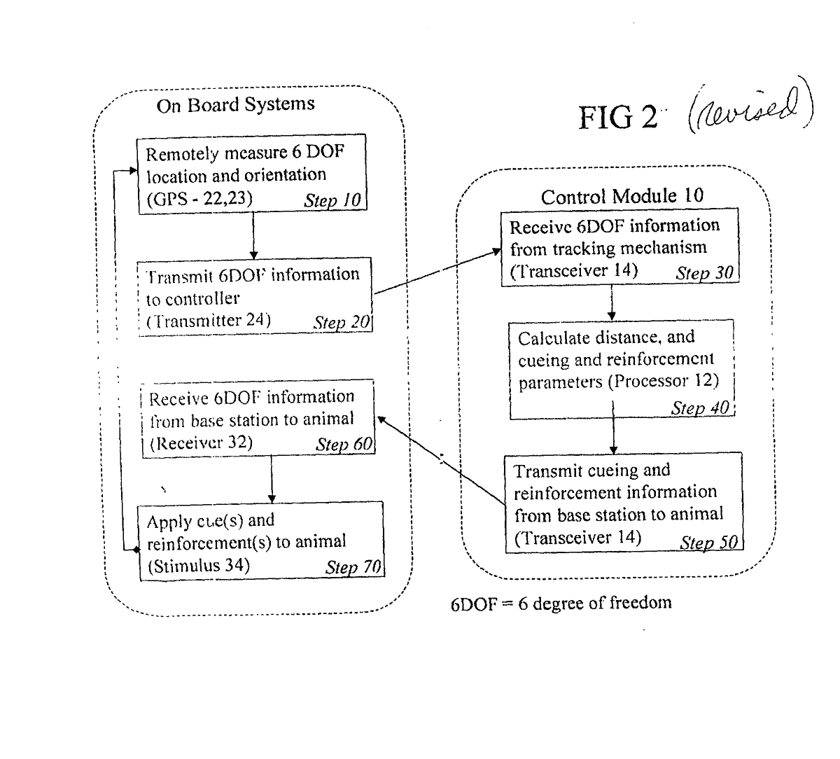

FIG. 2 is a flow chart showing the operation of the embodiment shown in FIG. 1, and more specifically, the method of interaction between the controller 10, onboard tracking mechanism 20, and onboard stimulus mechanism 30. At step 10, the differential GPS receiver 22 and electronic Compass 23 of onboard tracking mechanism 20 remotely measures location and orientation data. At step 20, the location and orientation data is sent by transmitter 24 to back to the controller 10. At step 30, the transceiver 14 of controller 10 receives the location and orientation data sent by transmitter 24. At step 40, processor 12 of controller 10 calculates the distance between the current position and the desired position of the animal (“differential distance”), calculates the angular difference between the current orientation and the desired orientation of the animal (“differential orientation”), and then calculates stimulus and reinforcement parameters based on the differential distance and orientation. At step 50, the stimulus and reinforcement parameters are then sent back to the remote stimulus mechanism 30 by the transceiver 14 of controller 10.

At step 60, the receiver 32 of the remote stimulus mechanism 30 receives the stimulus and reinforcement parameters from control module 10, and at step 70 the stimulus of the remote stimulus mechanism 30 applies the cues and reinforcements to the animal in accordance with the differential distance and differential orientation. The process repeats itself every few seconds.

The present invention includes a novel way of calculating the stimulus and reinforcement parameters based on differential distance and differential orientation so as to produce a gradient stimulus function. In this exemplary context, the remote stimulus module 30 generates an audio stimulus that is volume-dependent on the animal's location as well as tonally-dependent on orientation.

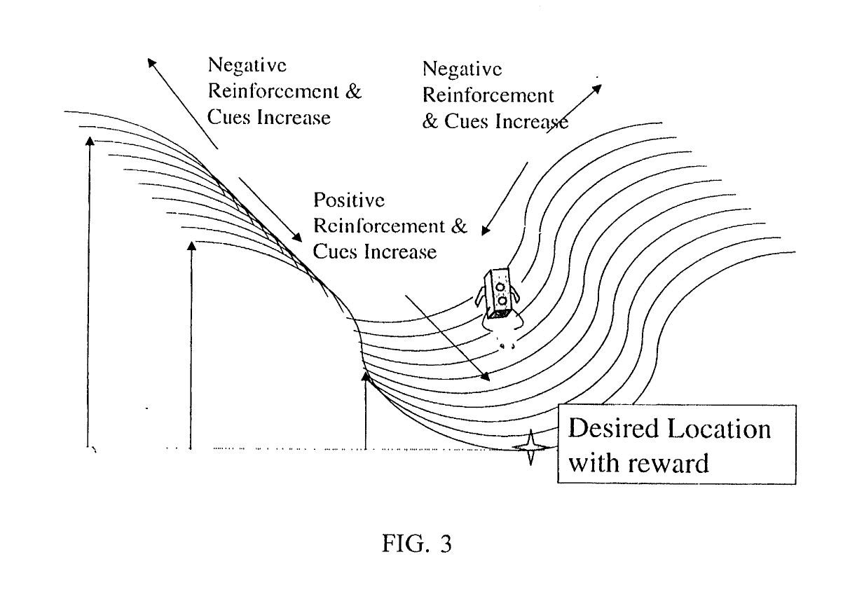

The calculations are completed by controller 10, and FIG. 3 is a graph of the gradient stimulus and reinforcement function generated by the controller 10 for the differential distance. The degree of reinforcement varies with differential distance (distance from desired location). Specifically, as the animal moves down the slope of the virtual landscape (closer to the desired location), negative reinforcements are reduced and positive reinforcements are increased. Conversely, as the animal moves up the slope of the virtual landscape (farther away from the desired location), negative reinforcements are increased and positive reinforcements are reduced. Similarly, audio tones are applied to cue the animal concerning the correctness of its location and orientation.

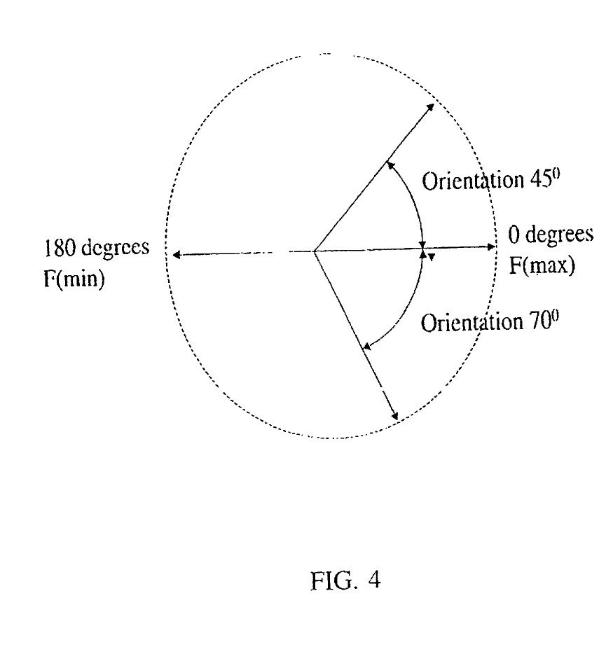

FIG. 4 illustrates a gradient stimulus and reinforcement function in the context of audio tone stimulus which is generated by the controller 10 in accordance with differential orientation. The tone moves toward a positive tone frequency [F(pos)] and away from a negative tone frequency [F(neg)] as the animal orients itself properly. At 0 degrees (the desired orientation), the tone frequency will equal F(pos). The desired direction at any instant in time corresponds to the largest negative slope on the virtual landscape as shown in FIG. 3. At 180 degrees from the desired direction, the tone frequency is decreased to F(neg). The algorithm used to determine the tone frequencies as a finction of angle may be a simple linear function or a more complex nonlinear function as desired. One example of a simple linear finction is as follows: F=F(max)−((F(max)−F(min)) * orientation/180), where orientation is the angle clockwise or counterclockwise from 0 degrees and varying between 0 and 180 degrees.

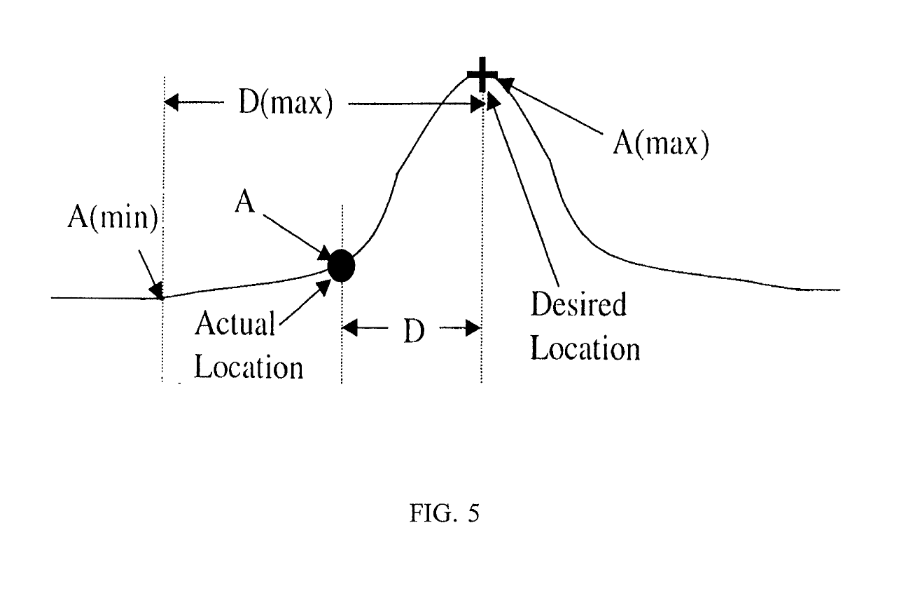

The tone amplitude is location-dependent, and FIG. 5 illustrates a gradient amplitude stimulus and reinforcement function. As the animal moves towards the desired location the tone amplitude is increased until it reaches A(max) at the desired location. Conversely, the amplitude will decrease to a minimum A(min) as the animal moves away from the desired orientation. At any distance beyond the maximum distance D(max), the amplitude preferably stays at A(min) so that the animal will always be provided with some level of cue. The stimulus function can also be a simple step function, a linear function (e.g., A=A(max) * D/D(max)), or a more complex nonlinear function as desired. Obviously, the D(max), A(min), and A(max) may be adjusted to provide optimum stimulus depending upon the animal, situation, and environment.

As an alternative to using tone frequency and amplitude to cue the animal as desired, a tonal stimulus mechanism can exploit tone phase as a cue using geolocation. This would require that the system employ headphones attached to the animal's ears, and a sound would be generated from a virtual fixed point in space. The virtual sound position would be adjusted to provide the requisite stimulus.

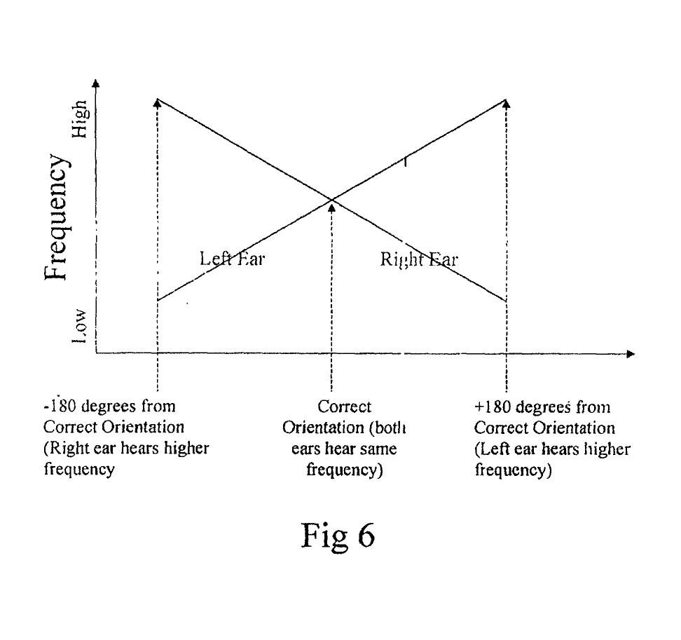

Similarly, a tonal cueing mechanism can be created by providing differential tones to each ear. FIG. 6 illustrates a gradient stimulus and reinforcement function in the context of a tonal cueing mechanism that provides differential tones to each ear. When the tones match across both ears, then the animal is facing the correct direction. When the tones do not match, then the animal is cued that it is not facing in the correct orientation.

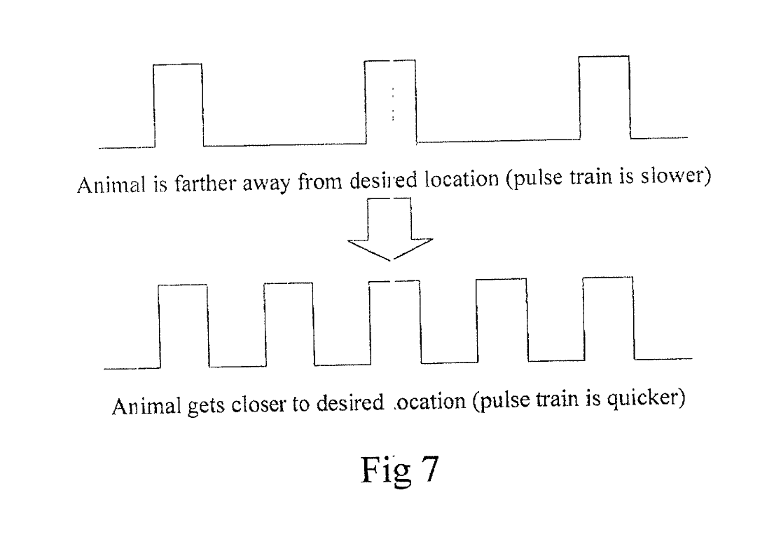

Similarly, distance cueing might use pulse train modulation as a cue instead of amplitude. FIG. 7 illustrates a stimulus and reinforcement pulse train. As the animal gets closer to the desired location, the pulse train quickens to a faster pace (e.g., quicker succession of beeps) in accordance with the gradient function previously described.

There are many alternatives to tonal stimulus. Other stimulus mechanisms can be used such as electrical (mildly aversive cutaneous shock) and mechanical (physical bridle or vibrations). Via repetition, the animal learns to associate the stimulus signals with incremental receipt of reward for correct movement to a target location where the strongest reward is received.

The above-described method and apparatus for controlling the movement of animals at a distance has numerous practical applications as follows:

1. Automated Animal Training

Using computer automation, the invention can be used to train numerous animals concurrently under computer control and without extensive human input. Under such an application, the computer monitors the animal's location and movement and automatically provides positive and/or negative cueing and reinforcement based on the animal's actions. Such automated training will significantly reduce training times and labor costs.

2. Cargo Deployment.

In addition to the deployment of sensors, this invention will provide a platform to deploy cargo into remote or restrictive areas. Examples include remotely guided dogs or horses delivering food or communications equipment to individuals trapped in restrictive areas or delivering cargo designed to negate lethal threats such as mine neutralization packages.

3. Search and Rescue

Several dogs can be remotely deployed in sectors to search for people lost in heavily forested or mountainous terrain. The dogs can autonomously search in sectors defined and controlled either by human or computer operators. This application can reduce the need for human operators to deploy with the search dogs. This way, animals can be deployed into restricted areas unreachable by humans. For example, rats might be guided into earthquake rubble to find victims buried in the rubble or marine mammals might be guided to search for items in deep water.

4. Reconnaissance and Remote Monitoring:

Animals can reduce the need for large infrastructures to support current man-made platforms. For example, Unattended Aerial Vehicles (UAVs) are used for aerial reconnaissance. These systems can be extremely expensive and require extensive support systems (such as gasoline, maintenance crews, and launch and recovery systems) to keep them flying. A UAV can potentially be replaced by a bird controlled in accordance with the present invention. If not for the actual reconnaissance, then animals such as a dogs can be deployed to stay and monitor a location or to deploy a remote sensor. A rat can be used to covertly deploy chemical, biological, or microphone sensors into buildings (via air conditioning ducts) suspected of harboring weapons of mass destruction. Or a bird could deploy sensors onto the roof of a building to monitor terrorist activities. Similarly, a bird might fly over an enemy encampment to provide video surveillance. In the commercial arena, rats might be moved into pipes or other areas too small for humans to deploy diagnostic equipment or to diagnose failures. In addition to deploying external sensors, internal man-made sensors could be embedded into biological entities to reduce their likelihood of discovery (e.g., hide microphones in an animal's ears).

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth herein.

I Claim:

1. A method for controlling animal behavior comprising the steps of:
monitoring the behavior of an animal relative to a behavioral goal;
providing gradient feedback to said animal as a function of degree of deviation of actual behavior from the behavioral goal as monitored in said monitoring step.

2. A method for controlling animal behavior comprising the steps of:
monitoring the location and orientation of the animal;
providing a first gradient reinforcement stimulus to said animal as a function of degree of deviation of said location from a desired location;
providing a second gradient reinforcement stimulus to said animal as a function of degree of deviation of said orientation from a desired orientation.

3. A device for controlling animal behavior, comprising:
an onboard tracking module to be worn by an animal for monitoring location and orientation and for transmission of data indicative thereof to a remote location;
a control module in communication with said onboard tracking module for receiving said data and for calculating, generating and transmitting stimulus control parameters to the animal; and
an onboard stimulus module to be worn by said animal for providing gradient feedback to said animal as a function of degree of deviation of location and orientation from desired location and orientation.

4. The device for controlling animal behavior as in claim 3, wherein said onboard tracking module includes a differential GPS receiver and electronic compass connected to a transmitter.

5. The device for controlling animal behavior as in claim 3, wherein said onboard tracking module includes a video camera for direct visual observation.

6. The device for controlling animal behavior as in claim 3, wherein said onboard stimulus module further comprises a receiver connected to a stimulus-imparting device for applying feedback to the animal.

7. The device for controlling animal behavior as in claim 6, wherein said stimulus-imparting device imparts any one from among the group of stimuli comprising neural, aural, visual, and electric shock.

8. The device for controlling animal behavior as in claim 3, wherein said control module comprises a microprocessor.

9. The device for controlling animal behavior as in claim 8, wherein said control module is remote from said stimulus and onboard tracking modules and further comprises a transceiver for communications therewith.
